(19) United States
(12) Patent Application Publication
(10) Pub. No.: US 2012/0110966 A1
(43) Pub. Date: May 10, 2012

(54) LAWN MOWER POWERED BY A COMPRESSION-IGNITION COMBUSTION ENGINE THAT UTILIZES MULTIPLE FUEL TYPES

(76) Inventors: Yen Wen Wong, Dongguan (CN); Mark Wong, Sydney (AU); Sam Horatic Lancaster Andrews, Melbourne (AU)

(21) Appl. No.: 13/278,098

(22) Filed: Oct. 20, 2011

Related U.S. Application Data
(63) Continuation of application No. 12/854,577, filed on Aug. 11, 2010, now abandoned.

(51) Int. Cl. A01D 34/68

(52) U.S. Cl. 56/17.5

(57) ABSTRACT

The present invention is a lawn mower powered by a compression ignition combustion engine that can utilize multiple fuel types such as petroleum based fuels or plant based fuels or any combination thereof. The lawn mower includes a chassis with a rear end having a plurality of spaced wheels, a compression ignition engine mounted on the chassis to provide power to the lawn mower and one or more grass cutting blades mounted directly or indirectly on an output shaft of the compression ignition engine. The lawn mower also includes a handle projecting from the rear end of chassis and a fuel tank, a fuel line, a fuel pump and a fuel injector to provide the multiple fuel types to the compression ignition engine.

This patent application claims priority to U.S. Provisional Application No. 61/232,879 filed on Aug. 11, 2009 which was the bases and priority of U.S. NON provisional application 12/854,577 filed Aug. 11, 2010, both the disclosures of which are incorporated herein by reference in its entirety. The present application is a continuation of U.S. NON provisional application 12/854,577 filed Aug. 11, 2010.

### TECHNICAL FIELD & BACKGROUND

Currently on the market, most walk-behind lawnmowers are powered by spark-ignition combustion engines. For a long time, both spark-ignition and compression-ignition engines were fueled by liquid petroleum-derived fuels and were used in similar applications. The main difference between these two types of engines is the methods of initiating fuel combustion. Spark-ignition engines rely upon an external source of energy to initiate the combustion of fuel and air within the engine cylinder. This energy is provided by a spark plug as the terminal element in the engine's electrical ignition system. The compression ignition engines rely upon the fuel to self-ignite upon reaching the proper air/fuel ratio, temperature, and pressure. Apart from the fact that compression ignition engines are more fuel efficient than spark-ignition combustion engines, compression ignition engines can be adapted to utilize multiple types of fuels. These fuels include petroleum diesel, clean petroleum diesel such as ultra-low sulfur diesel or ULSD, synthetic diesel, gas to liquid diesel, kerosene, home heating oil, civil jet fuel, military jet fuel, esterified plant oil, non-esterified plant oil, and any mixed blends of these fuels.

It has been identified there are more than 1,000 oil producing plants around the world. One of the advantages of using esterified and non-esterified plant oil as engine fuels compared to using petroleum-based engine fuels is the reduction of greenhouse gases such as the amount of carbon monoxide and carbon dioxide to be released into the atmosphere. In the entire world, pollution caused by using lawn and gardening equipment can not be neglected. In the United States alone, this type of pollution is about 5% of its national total pollution. Furthermore, plant oil, esterified or non-esterified, as a fuel is a biomass fuel and is considered to be carbon neutral. Walk-behind lawnmowers have relatively less working intensity and working life compared to road related vehicles. These characteristics make it possible to utilize a compression ignition engine with plant oil as a fuel. This is because some of the problems associated with burning non-esterified plant oil (such as carbon and fatty acid built-up) are not so severe. Non-esterified plant oil includes pure plant oil (PPO), straight vegetable oil (SVO), used cooking oil (UCO) and waste vegetable oil (WVO). Esterified plant oil is mostly regarded as plant oil (both used and non-used) being processed to become biodiesel. Most compression ignition combustion engines, directly injected (DI) or indirectly injected (IDI) can run on all abovementioned fuels without any substantial modification.

It is an object of the present invention to provide a walk-behind lawnmower which is powered by a single cylinder compression ignition combustion engine.

Another object of the present invention is to provide a walk behind mower that can utilize multiple types of fuels such as diesel fuel, clean diesel fuel, esterified plant oil and non-esterified plant oil, as well as other types of suitable fuels.

An object of the invention is to provide a walk-behind lawnmower that is powered by a compression ignition combustion engine.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side diagonal perspective view of a walk behind mower powered by a compression ignition engine that can utilize multiple fuel types, in accordance with one embodiment of the present invention.

FIG. 2 illustrates a side perspective view of a walk behind mower powered by a compression ignition engine that can utilize multiple fuel types, in accordance with one embodiment of the present invention.

FIG. 3 illustrates a top perspective view of a walk behind mower powered by a compression ignition engine that can utilize multiple fuel types, in accordance with one embodiment of the present invention.

FIG. 4 illustrates a cross-sectional side perspective view along line 1-1 of FIG. 1 of the chase of a walk behind mower powered by a compression ignition engine that can utilize multiple fuel types, in accordance with one embodiment of the present invention.

FIG. 5 illustrates a cross-sectional side perspective view along line 4-4 of FIG. 4 of a cylinder head of a compression ignition engine that powers the walk behind mower, in accordance with one embodiment of the present invention.

FIG. 6 illustrates a cross-sectional side perspective view along line 5-5 of FIG. 5 of a cylinder head of a compression ignition engine that powers the walk behind mower, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

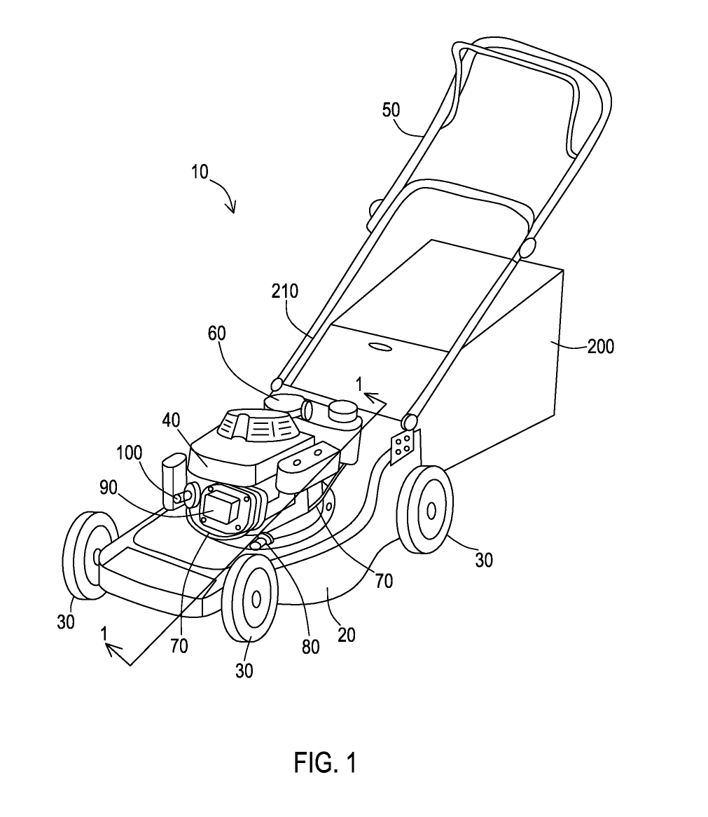

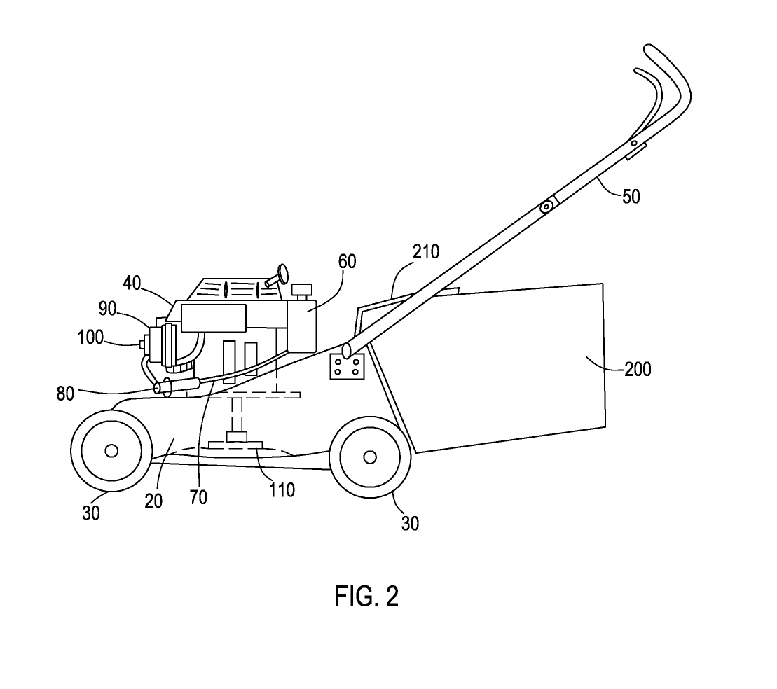

FIG. 1 illustrates a side diagonal perspective view of a walk-behind mower 10 powered by a compression ignition engine 40 that can utilize multiple fuel types, in accordance with one embodiment of the present invention. The walk-behind mower 10 includes a chassis 20 having a plurality of spaced wheels 30, a compression ignition engine 40 mounted on the chassis 20, one or more grass cutting blades (FIG. 2, 110) mounted directly or indirectly on the engine's output shaft (not shown) and a handle 50 projecting from the rear end of the chassis 20. A fuel tank 60 is supported by the chassis 20 or the compression ignition engine 40. A fuel pump 80 and a cylinder head 90 are mounted on the compression ignition engine 40. A fuel injector 100 is mounted on the cylinder head 90 of the compression ignition engine 40. A fuel line 70 runs between the fuel tank 60 to the fuel pump 80 and between the fuel pump 80 to the fuel injector 100. Multiple types of fuels are supplied to the compression ignition engine 40 from the fuel tank 60 using the action of fuel pump 80 and the fuel injector 100 via fuel line 70 to cylinder head 90 in turn to compression ignition engine 40. The compression ignition engine 40 must have a compression ratio greater than 1:9 in-order to be ignited and to drive the walk-behind mower 10 using the supplied multiple types of fuels. Walk-behind mower 10 also comprises an optional grass bag/catcher 200 and an optional grass discharge port cover 210 which are mounted to the rear of the chassis 20.

FIG. 2 is a side view of the walk-behind mower 10 powered by a compression ignition engine 40 that can utilize multiple fuel types, in accordance with one embodiment of the present invention. The grass cutting blade 110 is directly or indirectly mounted on the output shaft of the engine 40. Compression ignition engine 40 is started by force of turning and supplied with fuel from the fuel tank 60 via fuel pump 80 and fuel injector 100. Fuel is injected into cylinder head 90 and compression ignition engine 40 and when compression ratio reaches above 1:10 the above mentioned multiple types of fuels ignite the engine 40. Grass cutting blade 110 is driven by the compression ignition engine 40 within the chassis 20 to cut the grass.

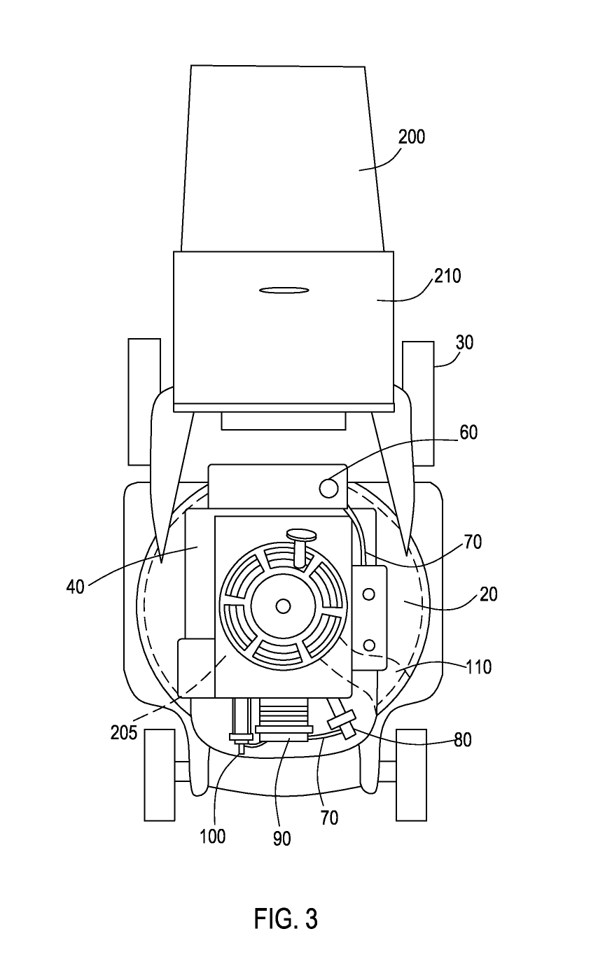

FIG. 3 is a plan view of the walk-behind mower 10 powered by a compression ignition engine 40 that can utilize multiple fuel types, in accordance with one embodiment of the present invention. Walk-behind mower 10 is shown as a rear-discharge type walk-behind mower 10. This is not to exclude other suitable types of walk-behind mowers 10 such as side discharge walk-behind mowers 10, in which an optional grass bag/catcher 200 and an optional grass discharge port cover 210 will not be of necessity. In a walk-behind mower 10 powered by a compression ignition engine 40 that can utilize multiple fuel types, when the compression ignition engine 40 is running, it can rotate the cutter blade 110 in a clockwise direction to cut grass on a lawn. The resulting grass clippings are driven, by a plurality of clockwise vortexes 205 produced by the rotating cutter blade 110, into the grass bag/catcher 210 through the scroll portion of the chassis 20.

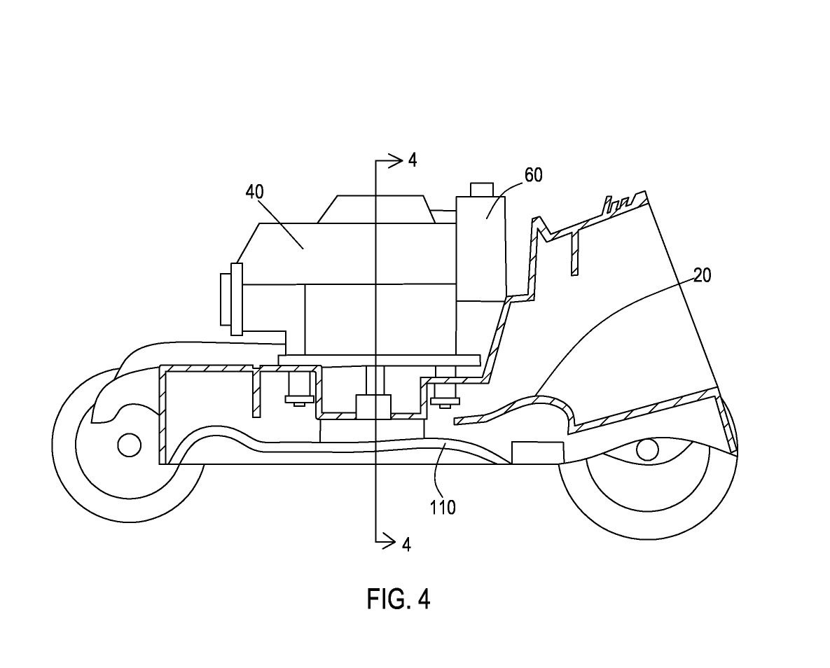

FIG. 4 is a sectional view of the walk-behind mower 10 powered by a compression ignition engine 40 that can utilize multiple fuel types, in accordance with one embodiment of the present invention. FIG. 3 illustrates that the cutting blade 110 is directly mounted on the output shaft of the compression ignition engine 40. FIG. 4 also illustrates how the compression ignition engine 40 is mounted on the walk behind mower's chassis 20.

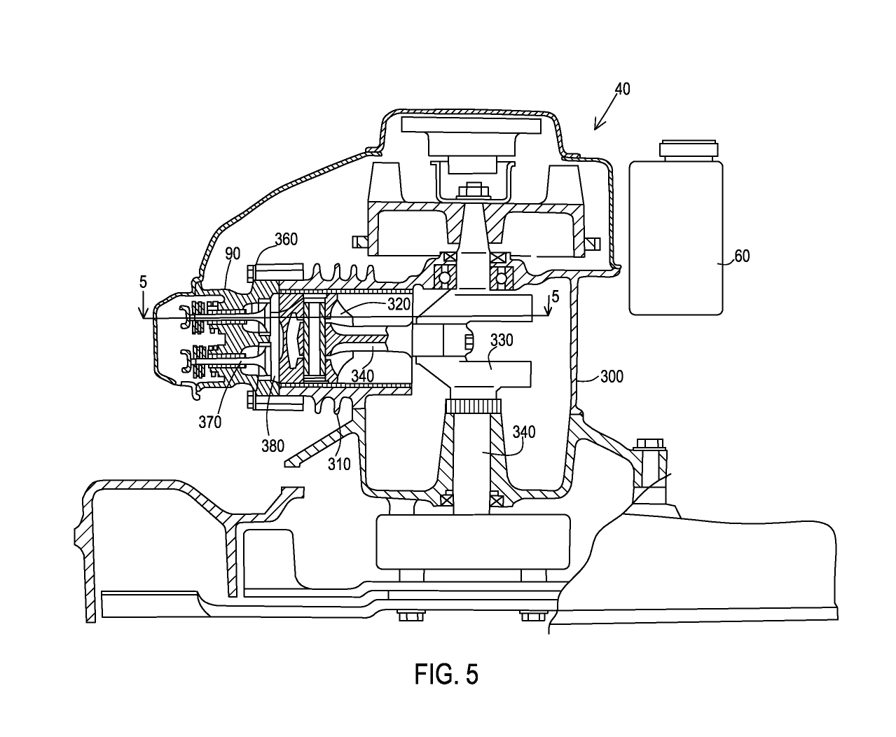

FIG. 5 illustrates a cross-sectional side perspective view along line 4-4 of FIG. 4 of a cylinder head of a compression ignition combustion engine that powers the walk behind mower, in accordance with one embodiment of the present invention. As illustrated in FIG. 5, the compression ignition engine 40 includes a main body/crank case 300 and a cylinder 310. Inside the cylinder 310, there is a piston 320. Inside the crank case 300 there are a crank shaft 330 and a link rod 340. The link rod connects piston 320 and crank shaft 330. An engine output shaft 340 is mounted on one end of the crank shaft 330. At the end of cylinder 310 fitted with a cylinder head 90. Inside the cylinder head 90 there are two valves, an air intake valve 360 and an exhaust valve 370. Between the two valves and the piston a space forms a combustion chamber 380.

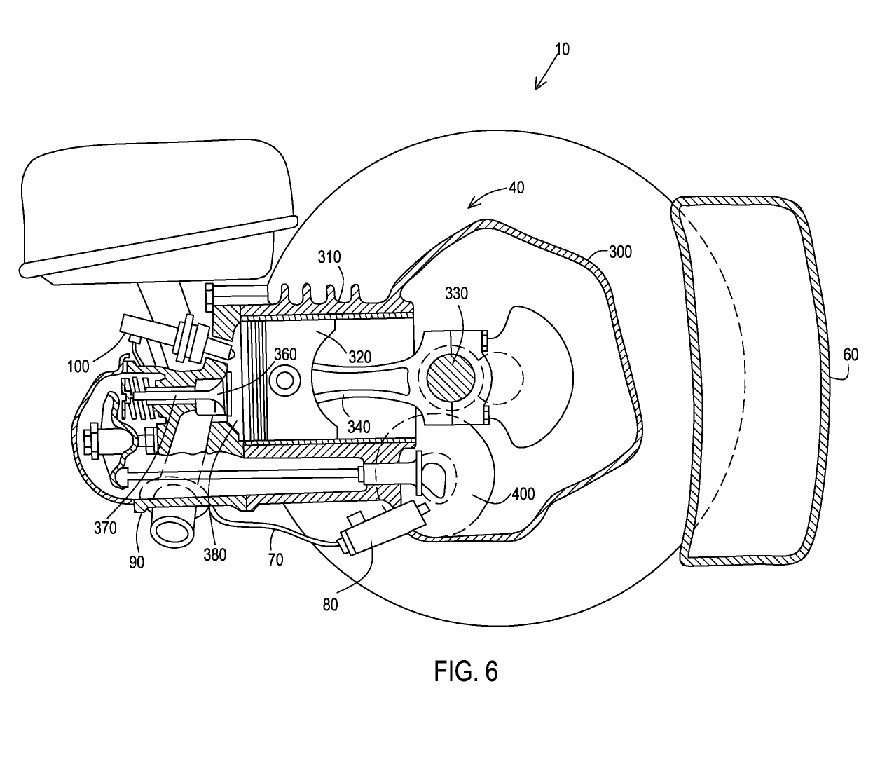

FIG. 6 illustrates a cross-sectional side perspective view along line 5-5 of FIG. 5 of a cylinder head of a compression ignition combustion engine that powers the walk behind mower, in accordance with one embodiment of the present invention. As illustrated in FIG. 6, a fuel pump 80 is driven by engine's camshaft 400. There is a fuel injector 100 mounted on the cylinder head 90. Fuel pump 80 supplies fuel to a fuel injector 100 via fuel line 70. Fuel is injected in to the combustion chamber 380 when both valves 360 and 370 are closed. When the engine compression ratio is greater than 1:9, compression in and the temperature in combustion chamber will be higher enough to ignite the certain types of fuel. These fuels include petroleum diesel, clean petroleum diesel such as ULSD (ultra-low sulfur diesel), synthetic diesel, gas to liquid diesel, kerosene, home heating oil, civil jet fuel, military jet fuel, esterified plant oil, non-esterified plant oil, and any mixed blends of these fuels.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A lawn mower that can utilize multiple fuel types, comprising:
a chassis with a rear end having a plurality of spaced wheels;
a compression ignition engine mounted on said chassis to provide power to said lawn mower;
one or more grass cutting blades mounted directly on an output shaft of said compression ignition engine;
a handle projecting from said rear end of chassis; and
a fuel tank, a fuel line, a fuel pump, and a fuel injector to provide said multiple fuel types to said compression ignition engine.

2. The mower according to claim 1, wherein said cutting blades are mounted indirectly on said output shaft of said compression engine.

3. The mower according to claim 1, wherein said compression ignition engine provides direct fuel injection to said compression ignition engine.

4. The mower according to claim 1, wherein said compression ignition engine provides indirect fuel injection to said compression ignition engine.

5. The mower according to claim 1, wherein said compression ignition engine has a compression ratio greater than 1 to 9 in order to be ignited and to drive said lawn mower using said multiple types of fuels.

6. The mower according to claim 5, wherein said compression ignition engine has a compression ratio of 1 to 10 in order to be ignited and to drive said lawn mower using said multiple types of fuels.

7. The mower according to claim 1, wherein said lawn mower is a walk-behind mower.

8. The mower according to claim 1, wherein said lawn mower is a rear discharge walk-behind mower.

9. The mower according to claim 1, wherein said lawn mower is a side discharge walk-behind mower.

10. The mower according to claim 1, wherein said fuel type is petroleum diesel.

11. The mower according to claim 10, wherein said fuel type is clean petroleum diesel.

12. The mower according to claim 1, wherein said fuel type is ultra-low sulfur diesel.

13. The mower according to claim 1, wherein said fuel type is synthetic diesel.

14. The mower according to claim 1, wherein said fuel type is gas to liquid diesel.

15. The mower according to claim 1, wherein said fuel type is gas to liquid kerosene.

16. The mower according to claim 1, wherein said fuel type is home heating oil.

17. The mower according to claim 1, wherein said fuel type is civic jet fuel.

18. The mower according to claim 1, wherein said fuel type is military jet fuel.

19. The mower according to claim 1, wherein said fuel type is esterified plant oil.

20. The mower according to claim 1, wherein said fuel type is non-esterified plant oil.
